(19) United States
(12) Patent Application Publication
(10) Pub. No.: US 2011/0304882 A1
(43) Pub. Date: Dec. 15, 2011

(54) IMAGE FORMING APPARATUS, CONTROL METHOD THEREOF, AND PROGRAM

(75) Inventor: Masahiro ODAIRA, Kawasaki-shi (JP)

(73) Assignee: CANON KABUSHIKI KAISHA, Tokyo (JP)

(21) Appl. No.: 13/154,031

(22) Filed: Jun. 6, 2011

(30) Foreign Application Priority Data
Jun. 11, 2010 (JP) 2010-134456

(51) Int. Cl. G06K 15/00

(52) U.S. Cl. 358/1.15

(57) ABSTRACT

The present invention provides an image forming apparatus connectable to a plurality of external apparatuses via a network, comprising: an acquisition unit that acquires, from the respective external apparatuses, pieces of copy setting information which are generated in the respective external apparatuses, the copy setting information designating apparatuses for scanning and apparatuses for printing; a determination unit that determines, by referring to the pieces of copy setting information acquired by the acquisition unit, whether or not each copy setting information designates the image forming apparatus as the apparatus for printing; and a display control unit that identifiably displays, on a display unit, copy setting information which is determined by the determination unit to designate the image forming apparatus as the apparatus for printing.

### BACKGROUND OF THE INVENTION

1. Field of the Invention

The present invention relates to an image forming apparatus, control method thereof, and program.

2. Description of the Related Art

Recently, image forming apparatuses need to achieve more sophisticated functions in addition to cost reduction and downsizing. As a measure to meet these demands, there is known a technique of performing information processing by an image forming apparatus and external apparatus in cooperation with each other to provide the best function and performance with limited hardware resources. In this technique, the image forming apparatus and the external apparatus (for example, server or PC) execute information processing and image processing in cooperation with each other, implementing an expansive function (for example, expansion copy function) which cannot be provided by the hardware resources of the image forming apparatus.

For example, Japanese Patent Laid-Open No. 08-186677 proposes a technique of connecting an image forming apparatus to an external apparatus such as a personal computer (to be referred to as a PC), and performing image processing by the PC for an image obtained by the image forming apparatus in order to provide a copy function. In Japanese Patent Laid-Open No. 08-186677, the PC executes image processing, which has been executed in the image forming apparatus for a conventional copy function, thereby reducing the use of the hardware resources of the image forming apparatus. In Japanese Patent Laid-Open No. 08-186677, the PC performs even operations (start of reading an original and various settings) of the image forming apparatus.

Image forming apparatuses propose an expansion copy function (pseudo-copy function). The expansion copy function, which cannot be implemented by the hardware resources of the image forming apparatus, is executed using the resources of an external apparatus such as a PC. Even this function can be operated on the operation unit of the image forming apparatus. For this purpose, a scan driver program for controlling the original reading function of the image forming apparatus, and a print driver program for controlling the print function are installed in the external apparatus. When the image forming apparatus receives a copy start instruction from the user, it notifies the external apparatus of the instruction. The external apparatus executes original reading, various image processes, and printing in accordance with each driver program. Although original reading and printing are done by the image forming apparatus, various image processes are executed using the hardware resources and driver program of the external apparatus. Even when the memory of the image forming apparatus has a small capacity, the expansion function enables layout processing and sort processing for multiple pages by storing image data in the memory of the external apparatus instead of the image forming apparatus. Further, the image forming apparatus includes only a minimum image processing unit, and an image processing program installed in the external apparatus performs complicated advanced image processing, color processing, and the like. This can improve the performance while reducing the cost of the image forming apparatus.

However, the conventional technique has the following problems. For the expansion copy function, the PC side can set, as a printout destination, an image forming apparatus different from one which scans an original. In such a case, a scanned image may be output to an image forming apparatus different from one which has started expansion copy, and printed out by an image forming apparatus the user does not expect.

### SUMMARY OF THE INVENTION

The present invention enables realization of an image forming apparatus which displays an expansion copy setting that designates the image forming apparatus as the printout destination, so that the user can easily select the expansion copy setting when executing an expansion copy function, and a control method thereof.

One aspect of the present invention provides an image forming apparatus connectable to a plurality of external apparatuses via a network, comprising: an acquisition unit that acquires, from the respective external apparatuses, pieces of copy setting information which are generated in the respective external apparatuses, the copy setting information designating apparatuses for scanning and apparatuses for printing; a determination unit that determines, by referring to the pieces of copy setting information acquired by the acquisition unit, whether or not each copy setting information designates the image forming apparatus as the apparatus for printing; and a display control unit that identifiably displays, on a display unit, copy setting information which is determined by the determination unit to designate the image forming apparatus as the apparatus for printing.

Another aspect of the present invention provides a method of controlling an image forming apparatus connectable to a plurality of external apparatuses via a network, comprising: acquiring, from the respective external apparatuses, pieces of copy setting information which are generated in the respective external apparatuses, the copy setting information designating apparatuses for scanning and apparatuses for printing; determining, by referring to the pieces of copy setting information acquired in the acquiring step, whether or not each copy setting information designates the image forming apparatus as the apparatus for printing; and identifiably displaying, on a display unit, copy setting information which is determined in the determining step to designate the image forming apparatus as the apparatus for printing.

Still another aspect of the present invention provides a computer-readable storage medium storing a computer program for causing a computer to execute the image forming apparatus control method.

Further features of the present invention will be apparent from the following description of exemplary embodiments with reference to the attached drawings.

### BRIEF DESCRIPTION OF THE DRAWINGS

FIG. 1 is a block diagram exemplifying the arrangement of an image forming apparatus according to an embodiment;

FIG. 2 is a view exemplifying the operation panel of the image forming apparatus according to the embodiment;

FIG. 3 is a view showing copy settings according to the embodiment;

FIG. 4 is a view exemplifying the configuration of an image forming system according to the embodiment;

FIG. 5 is a table showing copy settings in a plurality of external apparatuses according to the embodiment;

FIG. 6 is a flowchart of the image forming apparatus upon receiving copy setting information according to the embodiment;

FIG. 7 is a table showing a copy setting table held in the image forming apparatus according to the embodiment;

FIG. 8 is a flowchart showing the expansion copy operation of the image forming apparatus according to the embodiment;

FIG. 9 is a flowchart showing a copy setting list display operation according to the embodiment;

FIG. 10 is a flowchart showing a modification of the copy setting list display operation according to the embodiment;

FIG. 11 is a flowchart showing another modification of the copy setting list display operation according to the embodiment;

FIG. 12 is a table showing a copy setting list display according to the embodiment; and

FIG. 13 is a view showing copy settings according to the embodiment.

### DESCRIPTION OF THE EMBODIMENTS

Embodiments of the present invention will now be described in detail with reference to the drawings. It should be noted that the relative arrangement of the components, the numerical expressions and numerical values set forth in these embodiments do not limit the scope of the present invention unless it is specifically stated otherwise.

<Arrangement of Image Forming Apparatus>

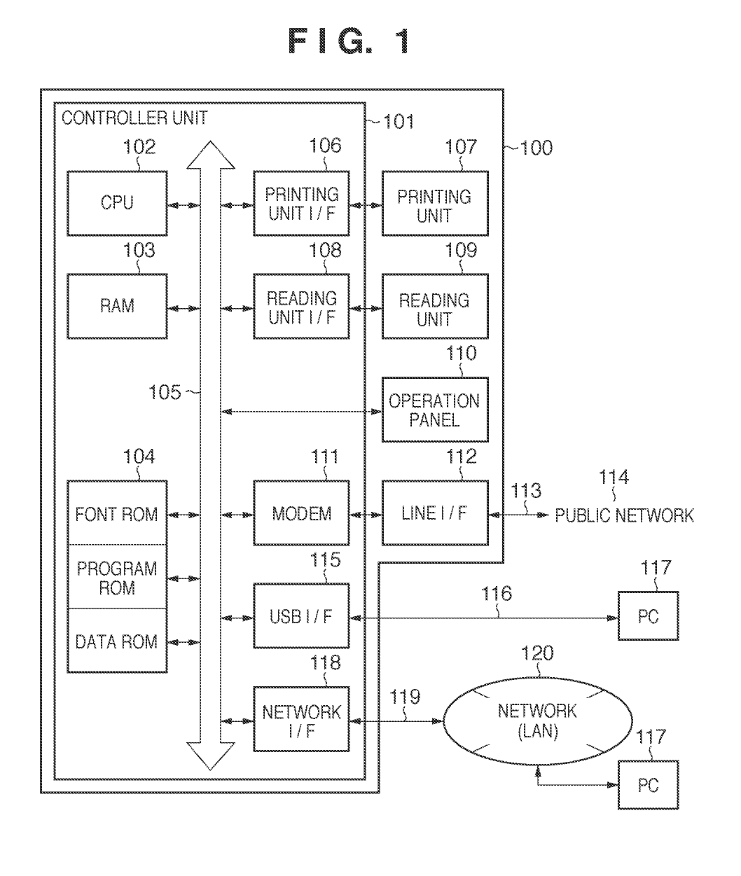

The arrangement of an image forming apparatus according to an embodiment of the present invention will be exemplified with reference to FIG. 1. As an example of the image forming apparatus, an MFP 100 will be explained. As shown in FIG. 1, the MFP 100 includes a printing unit 107, a reading unit 109, an operation panel 110, a line I/F 112, and a controller unit 101 which controls these units.

The controller unit 101 includes a CPU 102, RAM 103, ROM 104, printing unit I/F 106, reading unit I/F 108, modem 111, USB I/F 115, and network I/F 118. The respective blocks are connected by a system bus 105 to be able to communicate with each other. The CPU 102 comprehensively controls these blocks in accordance with various control programs. Various control programs are executed by reading out control programs stored in the program area of the ROM 104. For example, various control programs are executed by decompressing and rasterizing, to the RAM 103, compressed data which is stored in the program area of the ROM 104. Various control programs may be stored in a hard disk drive (HDD: not shown) in a compressed/uncompressed state.

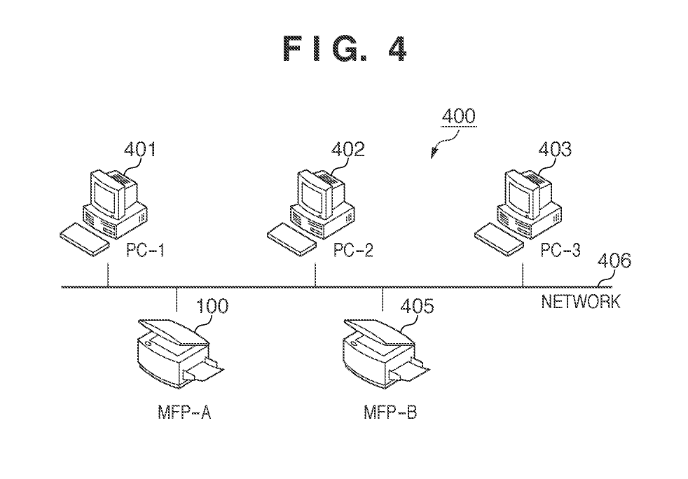

The network I/F 118 communicates with each host computer 117 (to be referred to as a PC) via a network (LAN) 120 or the like. Note that the PCs 117 correspond to PCs 401 to 403 to be described later with reference to FIG. 4 and subsequent drawings. The MFP 100 according to the embodiment can execute a cooperative job which is executed in cooperation with the PC 117 serving as an external apparatus or information processing apparatus. That is, the MFP 100 in the embodiment is connected to the PC 117 via the network, configuring an image forming system. The network I/F 118 and network 120 are connected via a communication cable such as a LAN cable 119. The modem 111 is connected to a public network 114 via the line I/F 112, and communicates with another image forming apparatus, facsimile apparatus, telephone set, and the like (none are shown). The line I/F 112 and public network 114 are generally connected via a telephone line 113 or the like.

The printing unit I/F 106 is an interface which outputs an image signal to the printing unit 107 (printer engine). The printing unit 107 forms an image on a printing medium in accordance with image data. The reading unit I/F 108 is an interface which inputs a read image signal from the reading unit 109 (scanner engine). The CPU 102 processes an image signal input via the reading unit I/F 108, and outputs it as a print image signal to the printing unit I/F 106.

By using font information stored in the font area of the ROM 104, the CPU 102 displays a character or sign on the display of the operation panel 110, or receives instruction information from the operation panel 110 which has received a user instruction. The CPU 102 stores apparatus information of the MFP 100, telephone book information of the user, department management information, and the like in the data area of the ROM 104, and if necessary, reads out and updates them.

<Arrangement of Operation Panel>

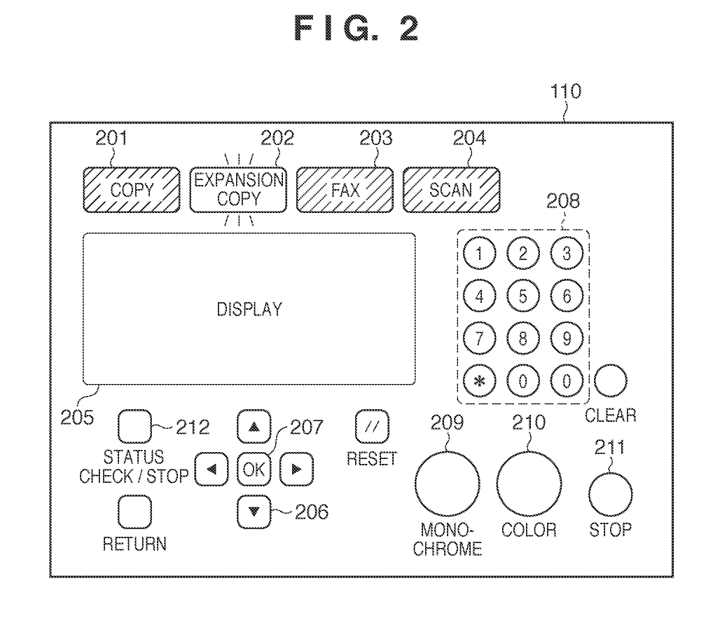

The operation panel 110 of the MFP 100 according to the embodiment will be described in detail with reference to FIG. 2. The MFP 100 according to the embodiment has a copy function implemented by the reading unit 109 and printing unit 107, and a scan function implemented by the reading unit 109 and USB I/F 115. In addition, the MFP 100 has a facsimile function implemented by the modem 111, and a function of printing in response to an instruction received from the PC 117 via a USB (Universal Serial Bus) 116 or the network 120.

The operation panel 110 will be explained. The operation panel 110 has function keys 201 to 204 for selecting the above-mentioned functions. The user presses the button of a function he wants to use. The operation panel 110 includes a display 205 for notifying the user of the setting status and the device status of the MFP 100. An arrow key 206 is used to move a cursor displayed on the display 205 or the like. As shown in FIG. 2, the arrow key 206 includes four, up, down, right, and left buttons. An OK key 207 is arranged at the center of the arrow key 206, and provides a “determination key” function for a setting or inquiry. For example, when the user wants to change a copy setting (paper size), he presses the copy function key 201 to enter the copy function screen, selects an item (paper size) to be changed using the arrow key 206, and presses the OK key 207. Then, the screen shifts to a selectable setting screen. The user moves the cursor to the position of a setting of his choice using the arrow key 206, and presses the OK key 207, thereby determining the setting. The user uses a ten-key pad 208 to input the copy count, a telephone number for the facsimile function, and the like.

The operation panel 110 includes a monochrome start key 209 and color start key 210 as keys for designating the start of copying, scanning, or facsimile processing. The embodiment assumes a color copy function, and the color start key 210 is illustrated. To the contrary, in an image forming apparatus having only a monochrome reading function or monochrome printing function, the start key may be only the monochrome start key 209. Further, the start key is not limited to the illustrated one even in an image forming apparatus having a function capable of determining which of color and monochrome originals is obtained when the original is read.

A stop key 211 is used to designate the stop of the operation of each function. As a method of stopping the operation, the user can select processing he wants to stop, and stop it by using a status check/stop key 212 from the status check screen of processes which are currently executed by the MFP 100. Also in this case, the user uses the arrow key 206 and OK key 207 for selection and determination.

<Copy Settings>

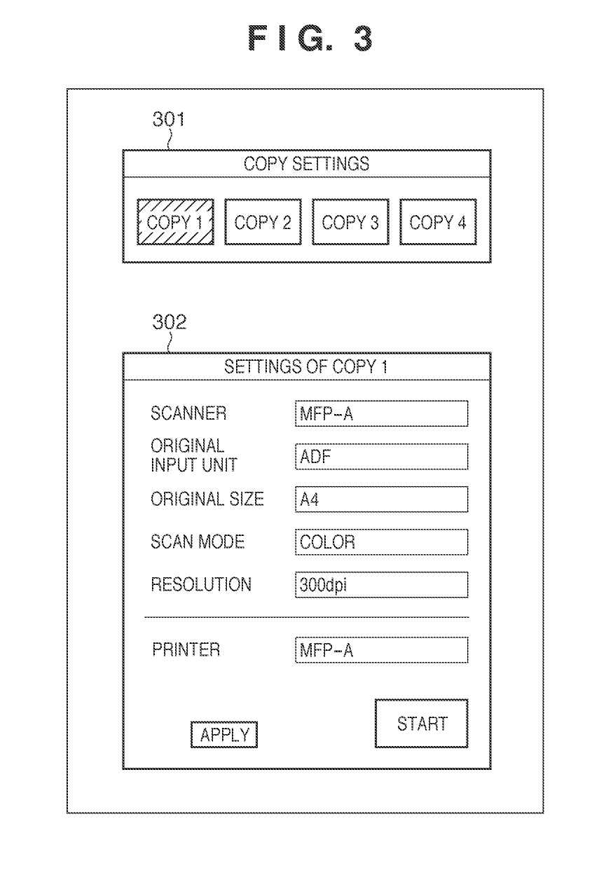

Copy settings according to the embodiment will be explained with reference to FIG. 3. FIG. 3 shows a copy setting screen 301 displayed on the display unit of the PC 117. The copy setting screen 301 is used to select a copy setting in expansion copy. The expansion copy is copy processing executed by, for example, the MFP 100 in cooperation with the PC 117. More specifically, the MFP 100 transmits, to the PC 117, image data obtained by reading an original by the MFP 100. The PC 117 performs image processing for the image data, and the MFP 100 prints in accordance with the image data having undergone the image processing. In expansion copy, an external apparatus such as the PC 117 executes image processing of a heavy processing load. This can reduce the processing load on the MFP 100 and also the cost because there is no need to install an advanced image processing module in the MFP 100.

As shown in FIG. 3, the copy setting screen 301 allows selecting a specific copy setting from, for example, a total of four kinds of copy settings, that is, copy 1, copy 2, copy 3, and copy 4. When the user selects copy 1 in the copy setting screen 301, a setting screen 302 regarding copy 1 appears.

In settings of copy 1 in the setting screen 302, the scanner is MFP-A, the original input unit is an ADF, the original size is A4, the scan mode is color, the resolution is 300 dpi, and the printer is MFP-A. By pressing the start button of the setting screen 302, expansion copy starts with these settings.

<Image Forming System>

An image forming system 400 including the image forming apparatus will be described with reference to FIG. 4. The image forming system 400 includes the PCs 401, 402, and 403 (sequentially corresponding to PC-1, PC-2, and PC-3) serving as external apparatuses, and the MFP 100 and an MFP 405 (sequentially corresponding to MFP-A and MFP-B) serving as image forming apparatuses. These apparatuses are connected via a network 406 to be able to communicate with each other. Note that the configuration of the image forming system is merely an example of the present invention, and is not intended to limit the types and number of apparatuses included in the image forming system.

<Control Regarding Copy Settings>

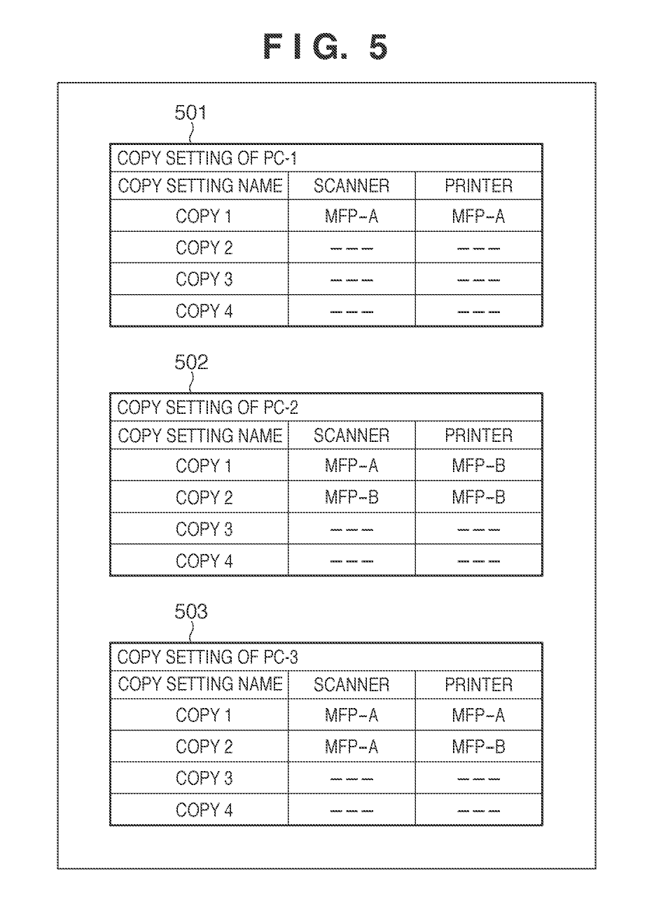

Control regarding copy settings of expansion copy or the like according to the embodiment will be described with reference to FIGS. 5 to 7. First, copy settings of expansion copy or the like in a plurality of external apparatuses according to the embodiment will be explained with reference to FIG. 5. Reference numeral 501 denotes a copy setting for the PC 401; 502, a copy setting for the PC 402; and 503, a copy setting for the PC 403. In the copy settings 501 to 503, designation information is set to designate image forming apparatuses as “scanner” and “printer” for respective copy setting names (copy 1 to copy 4). More specifically, designation information of an image forming apparatus which performs a scan operation to read an original in expansion copy is set as “scanner”. Designation information of an image forming apparatus which executes a printing operation in accordance with image data obtained by the scan operation in expansion copy is set as “printer”.

In the copy setting 501 of the PC 401, MFP-A is set as the scanner and printer for copy 1. For copy 2, copy 3, and copy 4, neither the scanner nor printer is set. In the copy setting 502 of the PC 402, MFP-A is set as the scanner and MFP-B is set as the printer for copy 1, and MFP-B is set as the scanner and printer for copy 2. For copy 3 and copy 4, neither the scanner nor printer is set. In the copy setting 503 of the PC 403, MFP-A is set as the scanner and printer for copy 1, and MFP-A is set as the scanner and MFP-B is set as the printer for copy 2. For copy 3 and copy 4, neither the scanner nor printer is set.

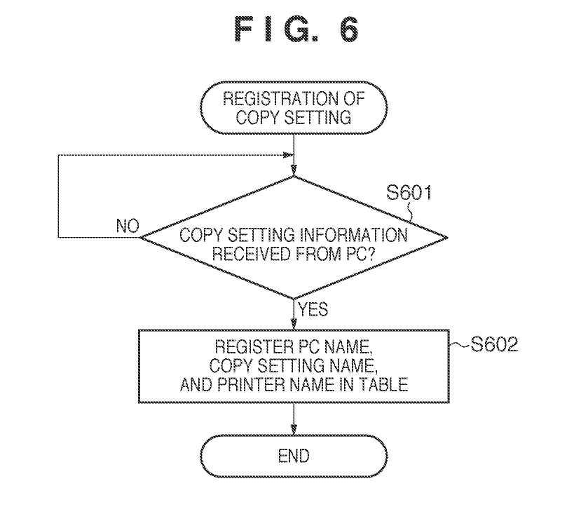

A processing sequence in the image forming apparatus upon receiving copy setting information according to the embodiment will be explained with reference to FIG. 6. The following processing is an example of processing by the MFP 100, and the CPU 102 implements the processing by reading out a program from the ROM 104 or the like and executing it.

If the CPU 102 determines in step S601 that it has received copy setting information (that is, the copy setting 501) from the PC 401, it advances to step S602. In step S602, the CPU 102 registers a PC name, copy setting name, and printer name in a table held in the image forming apparatus.

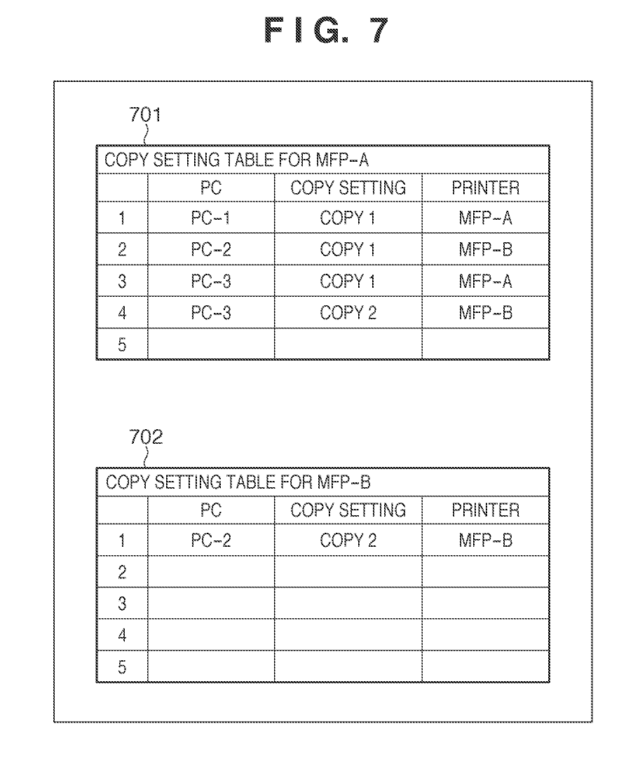

FIG. 7 shows a copy setting table held in the MFP 100. In FIG. 7, reference numeral 701 denotes a copy setting table for the MFP-A 100 in the arrangement of FIGS. 4 and 5; and 702, a copy setting table for the MFP-B 405 in the arrangement of FIGS. 4 and 5.

The MFP 100 is notified of copy settings which designate the MFP-A 100 as the scanner, out of the copy settings 501, 502, and 503 of the PCs 401, 402, and 403 shown in FIG. 5. In step S602, the CPU 102 registers the notified copy settings in the copy setting table 701. The MFP-B 405 is notified of copy settings which designate MFP-B as the scanner, out of the copy settings of the PCs 401, 402, and 403 shown in FIG. 5. In step S602, the CPU 102 registers the notified copy settings in the copy setting table 702.

<Expansion Copy>

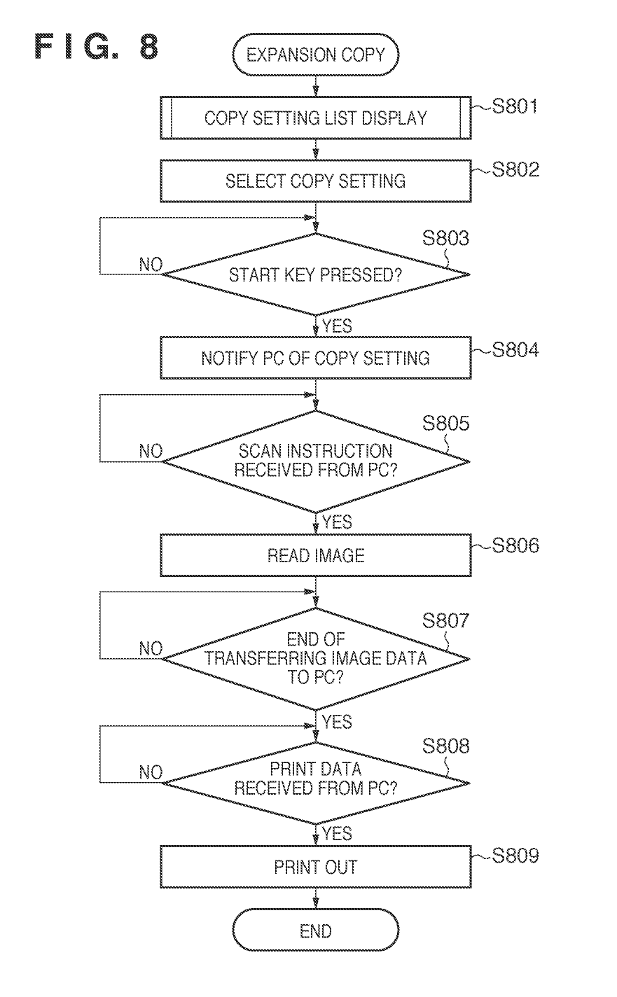

The processing sequence of expansion copy by the MFP 100 according to the embodiment will be explained with reference to FIG. 8. The CPU 102 implements the following processing by reading out a program from the ROM 104 or the like and executing it.

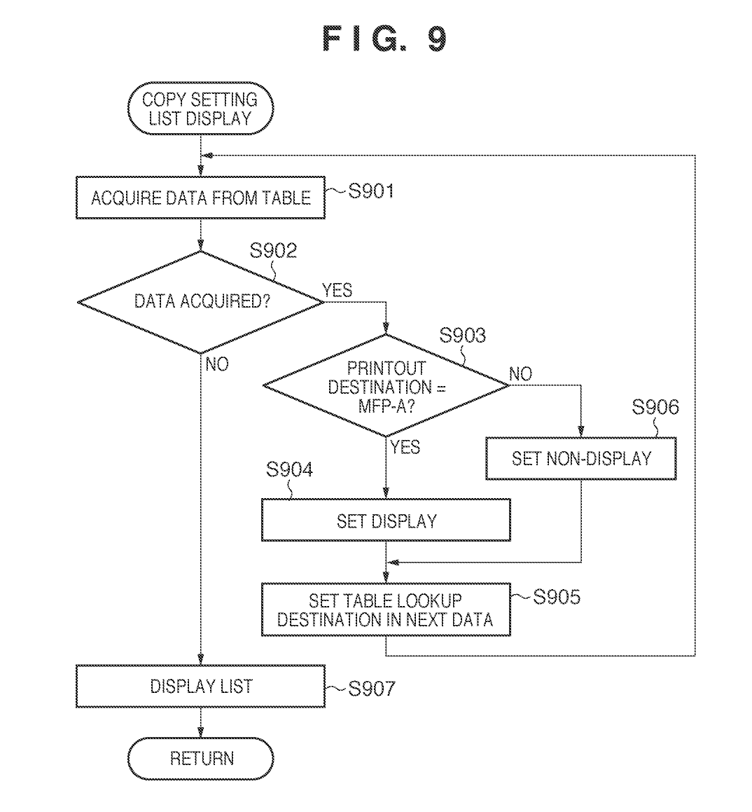

In step S801, the CPU 102 displays a copy setting list display screen on the display 205 based on the copy setting table registered according to the sequence of FIG. 6. The list display screen display method will be described later with reference to FIG. 9. In step S802, the CPU 102 selects a specific copy setting from the list displayed in step S801 based on a user operation. In step S803, the CPU 102 waits until it detects pressing of the start key 209 or 210. If the CPU 102 detects pressing of the start key 209 or 210, it advances to step S804.

In step S804, the CPU 102 notifies the PC 401 via the USB I/F 115 or network I/F 118 of the copy setting selected in step S802. In step S805, the CPU 102 waits until it receives a scan instruction from the PC 401 via the USB I/F 115 or network I/F 118. Upon receiving the scan instruction, the CPU 102 advances to step S806.

In step S806, the CPU 102 controls the reading unit 109 to start reading an original. In step S807, the CPU 102 transfers the image data read in step S806 via the USB I/F 115 or network I/F 118 to an external apparatus (in this case, the PC 401) serving as an expansion copy cooperation partner. Also in step S807, the CPU 102 determines whether the transfer has ended, and if YES, advances to step S808.

In step S808, the CPU 102 waits until it receives print data from the PC 401 via the USB I/F 115 or network I/F 118. Upon receiving print data, the CPU 102 advances to step S809 to print out the received print data by the printing unit 107, and then ends the process. In this manner, in expansion copy of the embodiment, the image forming apparatus transmits, to an external apparatus, image data obtained by scanning an original. The external apparatus performs image processing for the image data. The image forming apparatus receives the image data and prints it out.

<Copy Setting List Display>

The copy setting list display processing in step S801 will be explained in detail with reference to FIGS. 9 to 13. FIG. 9 shows details of the copy setting list display processing in step S801. Note that the CPU 102 implements the following processing by reading out a program from the ROM 104 or the like and executing it.

In step S901, the CPU 102 acquires one set of registered data from the copy setting table 701. In step S902, the CPU 102 determines whether the data have been acquired in step S901. If the data have been acquired, the CPU 102 advances to step S903, and determines whether the designation of the printout destination is MFP-A. If the CPU 102 determines that the printout destination is MFP-A, it advances to step S904; if NO, to step S906.

In step S904, the CPU 102 sets to display, in the list display, copy settings for which it is determined that the printout destination is MFP-A. The CPU 102 then advances to step S905. In step S906, the CPU 102 sets not to display, in the list display, copy settings for which it is determined that the printout destination is not MFP-A. The CPU 102 then advances to step S905.

In step S905, the CPU 102 sets the lookup destination of the copy setting table 701 in the next data, and returns to step S901. If the CPU 102 determines in step S902 that no data has been acquired in step S901, it advances to step S907, and displays a list of copy settings on the display 205 of the operation panel 110 based on the display/non-display settings made in steps S904 and S906.

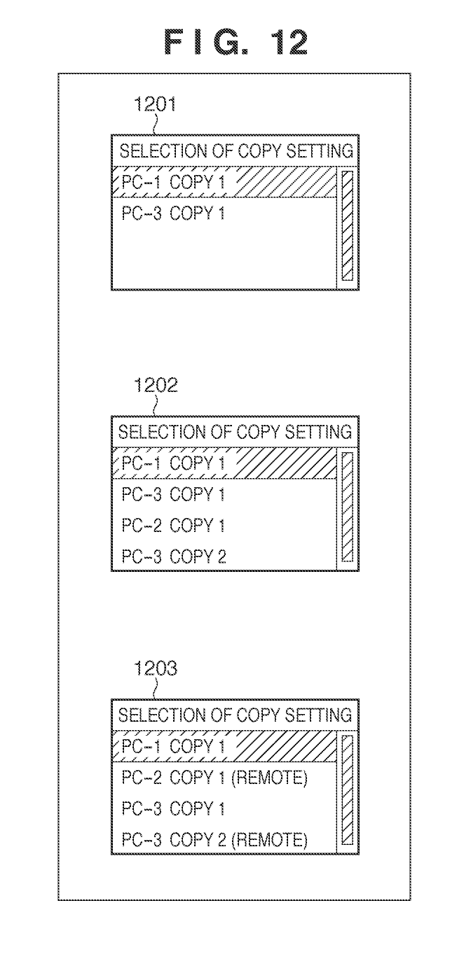

A display example according to the flowchart of FIG. 9 will be explained with reference to FIG. 12. Reference numeral 1201 denotes a display example of the display 205 when the copy setting table 701 is displayed based on the flowchart of FIG. 9. Only copy settings “PC-1 copy 1” and “PC-3 copy 1” in which MFP-A is set as the printer in the copy setting table 701 are displayed.

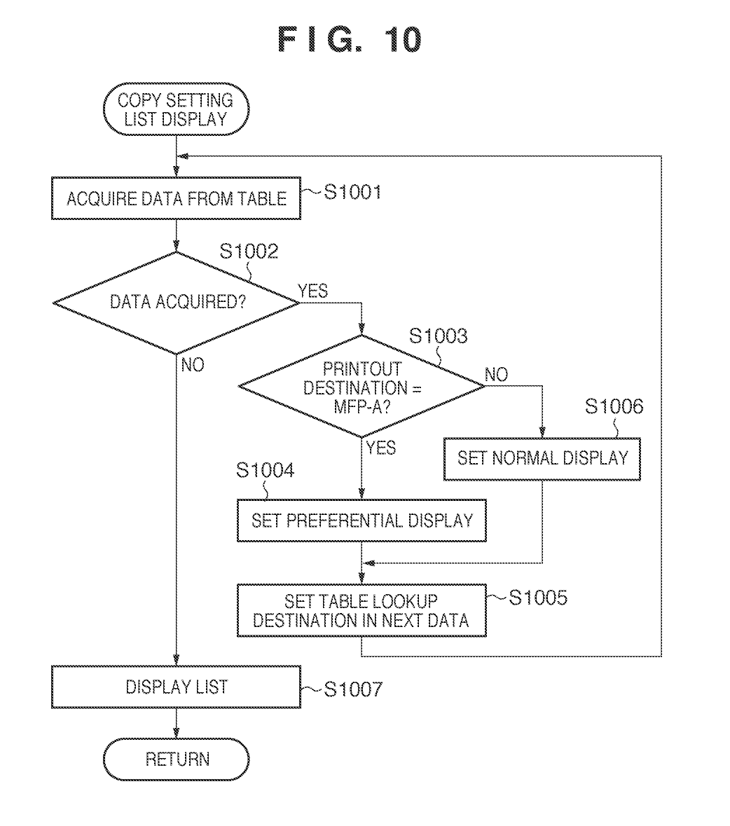

A modification of the copy setting list display will be explained with reference to FIG. 10. Note that the CPU 102 implements the following processing by reading out a program from the ROM 104 or the like and executing it. A description of the same processes as those in FIG. 9 will not be repeated. More specifically, steps S1001 to S1003 and S1005 are the same as steps S901 to S903 and S905, and a description thereof will not be repeated.

In step S1004, the CPU 102 sets to preferentially display, in the list display, copy settings for which it is determined that the printout destination is MFP-A. In step S1006, the CPU 102 sets to normally display, in the list display, copy settings for which it is determined that the printout destination is not MFP-A. In step S1007, the CPU 102 displays, on the display 205, a list of copy settings assigned with the preferential display setting in step S1004 such that they are positioned above copy settings assigned with the normal display setting in step S1005. That is, in the list display screen, copy settings for which it is determined that the printout destination is not MFP-A are displayed below those for which it is determined that the printout destination is MFP-A.

In FIG. 12, reference numeral 1202 denotes a display example of the display 205 when the copy setting table 701 is displayed based on the flowchart of FIG. 10. Copy settings “PC-1 copy 1” and “PC-3 copy 1” in which MFP-A is set as the printer in the copy setting table 701 are displayed above copy settings “PC-2 copy 1” and “PC-3 copy 2” in which MFP-B is set as the printer.

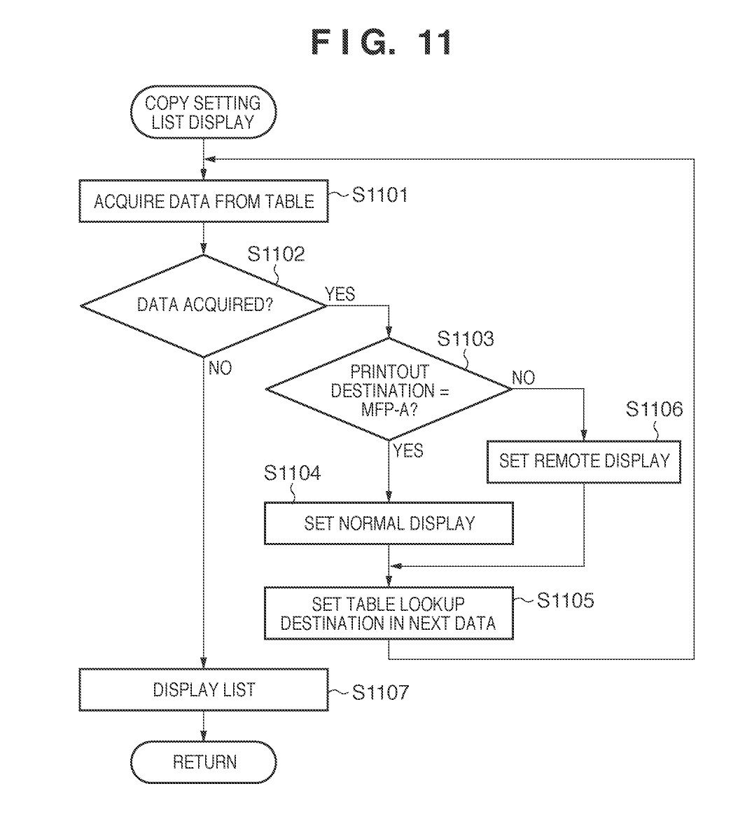

Another modification of the copy setting list display will be explained with reference to FIG. 11. Note that the CPU 102 implements the following processing by reading out a program from the ROM 104 or the like and executing it. A description of the same processes as those in FIG. 9 will not be repeated. More specifically, steps S1101 to S1103 and S1105 are the same as steps S901 to S903 and S905, and a description thereof will not be repeated.

In step S1104, the CPU 102 sets to normally display, in the list display, copy settings for which it is determined that the printout destination is MFP-A. In step S1106, the CPU 102 sets to display, in the list display together with “remote”, copy settings for which it is determined that the printout destination is not MFP-A. The remote display will be described later with reference to FIG. 12. In step S1107, the CPU 102 normally displays copy settings assigned with the normal display setting in step S1104. As for copy settings assigned with the remote display setting in step S1106, the CPU 102 displays a message that the printout destination is a remote one. That is, in the list display screen, copy settings for which it is determined that the printout destination is MFP-A are normally displayed. In addition, copy settings for which it is determined that the printout destination is not MFP-A are displayed identifiably.

In FIG. 12, reference numeral 1203 denotes a display example of the display 205 when the copy setting table 701 is displayed based on the flowchart of FIG. 11. Copy settings “PC-2 copy 1 (remote)” and “PC-3 copy 2 (remote)” in which MFP-B is set as the printer in the copy setting table 701 are displayed.

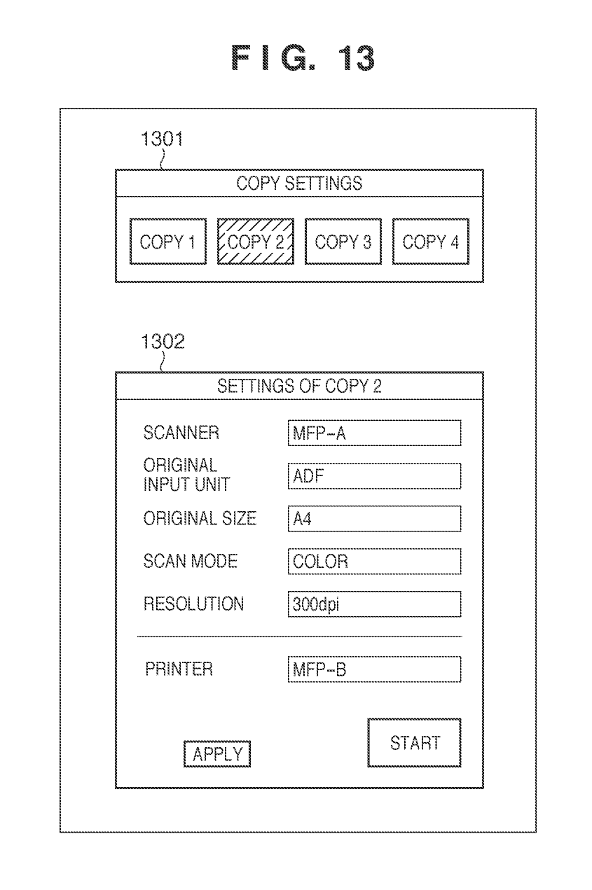

FIG. 13 is a view showing copy settings in the present invention. FIG. 13 shows a display screen when copy setting “copy 2” is selected in the PC 402. According to the flowchart of FIG. 9, copy setting “copy 2” of the PC 402 cannot be selected from the MFP-A 100. However, when the user presses a start button in a setting screen 1302, the PC 402 can execute expansion copy with a copy setting in which the MFP-A 100 is set as the scanner and the MFP-B 405 is set as the printer. In other words, by pressing the start button, the PC 402 can forcibly execute expansion copy with the setting “copy 2”.

As described above, the image forming apparatus according to the embodiment is connected to a plurality of external apparatuses such as a PC and MFP, and can execute the expansion copy function in cooperation with the external apparatus. The image forming apparatus acquires expansion copy setting information from the external apparatus, and displays a list of only copy settings in which the image forming apparatus is set as the printout destination, out of a plurality of acquired copy settings. Hence, the image forming apparatus allows the user to easily select a copy setting which designates, as the printout destination, the image forming apparatus from which the user is to start expansion copy.

Note that the present invention is not limited to the above embodiment, and various modifications can be made. For example, the image forming apparatus may display, in the list display screen, copy setting information in which the image forming apparatus is not the printout destination, below copy setting information in which the image forming apparatus serves as the printout destination. In addition to display of copy setting information in which the image forming apparatus serves as the printout destination, the image forming apparatus may identifiably display copy setting information in which the image forming apparatus is not the printout destination.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-134456 filed on Jun. 11, 2010, which is hereby incorporated by reference herein in its entirety.

What is claimed is:

1. An image forming apparatus connectable to a plurality of external apparatuses via a network, comprising:
an acquisition unit that acquires, from the respective external apparatuses, pieces of copy setting information which are generated in the respective external apparatuses, the copy setting information designating apparatuses for scanning and apparatuses for printing;
a determination unit that determines, by referring to the pieces of copy setting information acquired by said acquisition unit, whether or not each copy setting information designates the image forming apparatus as the apparatus for printing; and
a display control unit that identifiably displays, on a display unit, copy setting information which is determined by said determination unit to designate the image forming apparatus as the apparatus for printing.

2. The apparatus according to claim 1, wherein said display control unit further displays, in a display screen displayed on the display unit, copy setting information which is determined by said determination unit to designate the image forming apparatus as the apparatus for printing, above copy setting information which is determined by said determination unit not to designate the image forming apparatus as the apparatus for printing.

3. The apparatus according to claim 1, wherein said display control unit further displays, in a display screen displayed on the display unit, copy setting information which is determined by said determination unit to designate the image forming apparatus as the apparatus for printing, together with information indicating that the copy setting information designates the image forming apparatus as the apparatus for printing.

4. The apparatus according to claim 1, further comprising:
a scanner that reads an original to generate image data;
a transmission unit that transmits the image data generated by said scanner to an external apparatus;
a reception unit that receives image data having undergone image processing by the external apparatus; and
a printer that prints in accordance with the image data received by said reception unit.

5. A method of controlling an image forming apparatus connectable to a plurality of external apparatuses via a network, comprising:
acquiring, from the respective external apparatuses, pieces of copy setting information which are generated in the respective external apparatuses, the copy setting information designating apparatuses for scanning and apparatuses for printing;
determining, by referring to the pieces of copy setting information acquired in said acquiring step, whether or not each copy setting information designates the image forming apparatus as the apparatus for printing; and
identifiably displaying, on a display unit, copy setting information which is determined in said determining step to designate the image forming apparatus as the apparatus for printing.

6. A computer-readable storage medium storing a computer program for causing a computer to execute an image forming apparatus control method defined in claim 5.
